(19) United States
(12) Patent Application Publication
(10) Pub. No.: US 2020/0344368 A1
(43) Pub. Date: Oct. 29, 2020

(54) IMAGE PROCESSING DEVICE COMMUNICATING WIRELESSLY AND ELECTRONIC DEVICE USING THE SAME

(71) Applicant: TRIPLE WIN TECHNOLOGY(SHENZHEN) CO.LTD., Shenzhen (CN)

(72) Inventors: YING-LIN CHEN, New Taipei (TW); MING-HSUN LEE, New Taipei (TW)

(21) Appl. No.: 16/506,224

(22) Filed: Jul. 9, 2019

(30) Foreign Application Priority Data
Apr. 24, 2019 (CN) 201910335523.4

(51) Int. Cl. H04N 1/00; H04N 5/232

(52) U.S. Cl. CPC H04N 1/00315; G06T 1/00; H04N 2201/0055; H04N 5/23293

(57) ABSTRACT

An image processing device able to receive image and other data wirelessly for more reliable communication includes at least one a camera module and at least one a processing module. The camera module includes a lens, an image sensor configured for converting the captured light into electrical signals and a first integrated unit. The at least one processing module includes a processor configured for generating signals of an image according to the electrical signals, and a second integrated unit. The first integrated unit and the second integrated unit establish a non-contact wireless communication connection therebetween, thereby realizing communicating between the camera module and the processing module.

### FIELD

The subject matter herein generally relates to image processing.

### BACKGROUND

Smart electronic devices such as smart phones, personal computers, or the like are equipped with cameras having an image-capturing function. Hardware structures in the cameras, such as an image sensor and an image processor, can be electrically connected to each other through gold fingers or other connector for transmitting data therebetween. However, such contact type electrical connection structures may easily cause a poor contact, and affect a normal use of the cameras. Moreover, when an appearance or a size of the electronic devices is changed, the connection structure may require to be correspondingly redesigned, which may increase a product design cost and a design difficulty.

Therefore, there is room for improvement within the art.

### BRIEF DESCRIPTION OF THE DRAWINGS

Implementations of the present disclosure will now be described, by way of embodiment, with reference to the attached figures.

FIG. 1 is an isometric view of an embodiment of an electronic device.

FIG. 2 is a block diagram of a first embodiment of an image processing device of the electronic device of FIG. 1.

FIG. 3 is a block diagram of one embodiment of a first integrated unit and a second integrated unit in the device of FIG. 1.

FIG. 4 is a block diagram of a second embodiment of an image processing device.

FIG. 5 is a block diagram of a third embodiment of an image processing device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series, and the like.

The present disclosure is described in relation to an image processing device and an electronic device using the same.

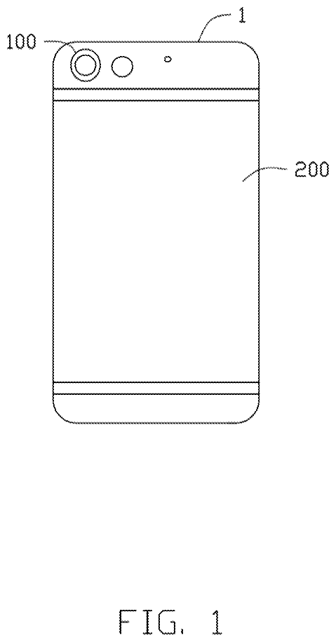

FIG. 1 illustrates an electronic device 1. The electronic device 1 can include, but is not limited to, an image processing device 100 and a housing 200. The image processing device 100 is positioned in the housing 200 for capturing an image in response to an image-capturing operation performed by a user to the electronic device 1.

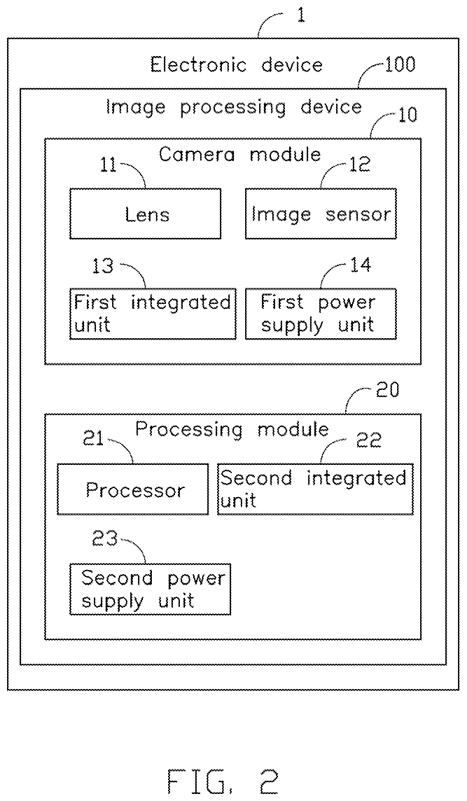

Referring to FIG. 2, the image processing device 100 includes, but is not limited to, a camera module 10 and a processing module 20. The camera module 10 at least includes a lens 11, an image sensor 12, a first integrated unit 13, and a first power supply unit 14. In this embodiment, the lens 11 is exposed from the housing 200 for obtaining light. The image sensor 12 can be one of a CCD (Charge-coupled Device) image sensor and a CMOS (Complementary Metal-Oxide-Semiconductor) image sensor. The image sensor 12 is configured for converting the light into electrical signals. The first power supply unit 14 is positioned in the camera module 10 and is configured for supplying electric power to the camera module 10. In other embodiment, the first power supply unit 14 can also be externally connected to the camera module 10.

The processing module 20 includes at least a processor 21, a second integrated unit 22, and a second power supply unit 23. In this embodiment, the processor 21 is configured for generating an image according to the electrical signals. The second power supply unit 23 is configured for supplying electric power to the processing module 20. A non-contact wireless communication connection is established between the first integrated unit 13 and the second integrated unit 22, thereby realizing communicating between the camera module 10 and the processing module 20. The signals (e.g. the electrical signals, the image as signals, or other commands from the user) can be transmitted between the first integrated unit 13 and the second integrated unit 22 by a short-range wireless communication protocol.

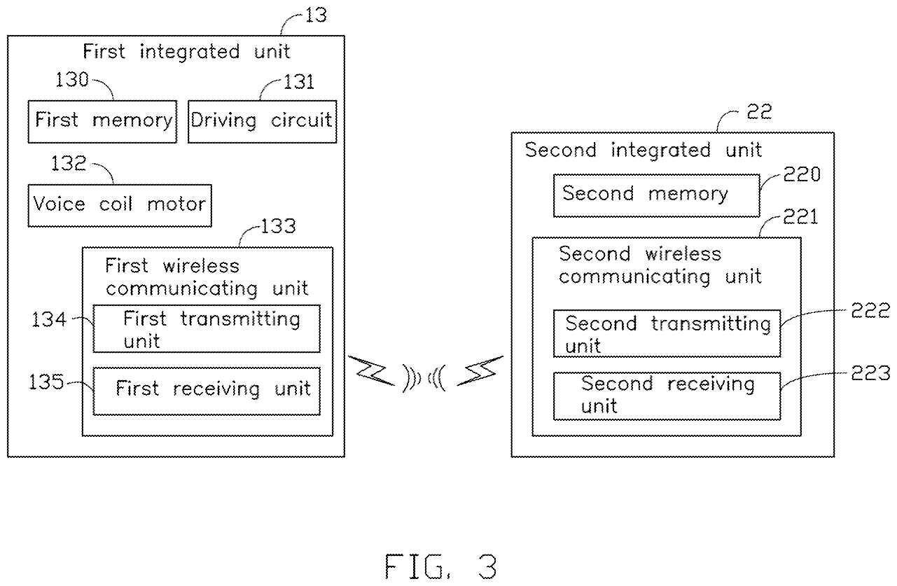

Referring to FIG. 3, the first integrated unit 13 at least includes a first memory 130, a driving circuit 131, a voice coil motor 132, and a first wireless communicating unit 133. In this embodiment, the first memory 130 can be of an EEPROM (Electrically Erasable Programmable Read Only Memory) memory and a flash memory configured for storing the image. The driving circuit 131 is configured for driving the image sensor 12. The voice coil motor 132 is electrically connected to the lens 11. The voice coil motor 132 is configured for adjusting a position of the lens 11. The first wireless communicating unit 133 is configured for communicating with the second integrated unit 22.

The second integrated unit 22 at least includes a second memory 220 and a second wireless communicating unit 221. In this embodiment, the second memory 220 can be one of a read only memory and a random access memory configured for storing the signals. The second wireless communicating unit 221 is configured for communicating with the first wireless communicating unit 133.

In this embodiment, the first wireless communicating unit 133 and the second wireless communicating unit 221 are both radio frequency radio modules. A wireless radio frequency connection can be established between the first wireless communicating unit 133 and the second wireless communicating unit 22. Data can be transmitted between the first wireless communicating unit 133 and the second wireless communicating unit 221 through electromagnetic induction. In this embodiment, the first wireless communicating unit 133 includes a first transmitting unit 134 and a first receiving unit 135. The second wireless communicating unit 221 includes a second transmitting unit 222 and a second receiving unit 223. The first transmitting unit 134 and the second transmitting unit 222 are configured for transmitting the signals to the second receiving unit 223 and the first receiving unit 135, and the first receiving unit 135 and the second receiving unit 223 are configured for receiving the signals from the second transmitting unit 222 and the first transmitting unit 134. In this embodiment, the signals transmitted between the first integrated unit 13 and the second integrated unit 22 at least includes MIPI (Mobile Industry Processor Interface) signals and I2C (Inter-Integrated Circuit, Serial bus) signals.

In other embodiments, the short-range wireless communication connection between the first wireless communicating unit 133 and the second wireless communicating unit 221 can be also be implemented through BLUETOOTH, ZIGBEE, NFC, or the like.

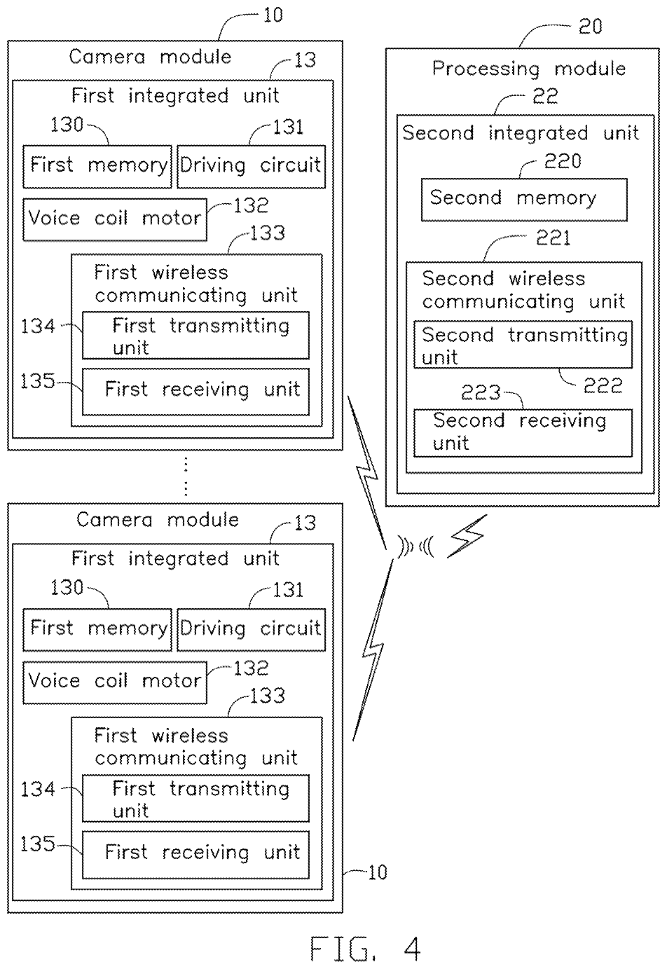

FIG. 4 illustrates a second embodiment of an image processing device. The image processing apparatus 300 includes a plurality of camera modules 10 and a processing module 20. The processing apparatus 300 is suitable for an electronic device 200 integrated with multiple cameras. The first integrated unit 13 of each camera module 10 is connected to the second integrated unit 22 of the processing module 20 through a wireless communication connection for transmitting or/and receiving the signals.

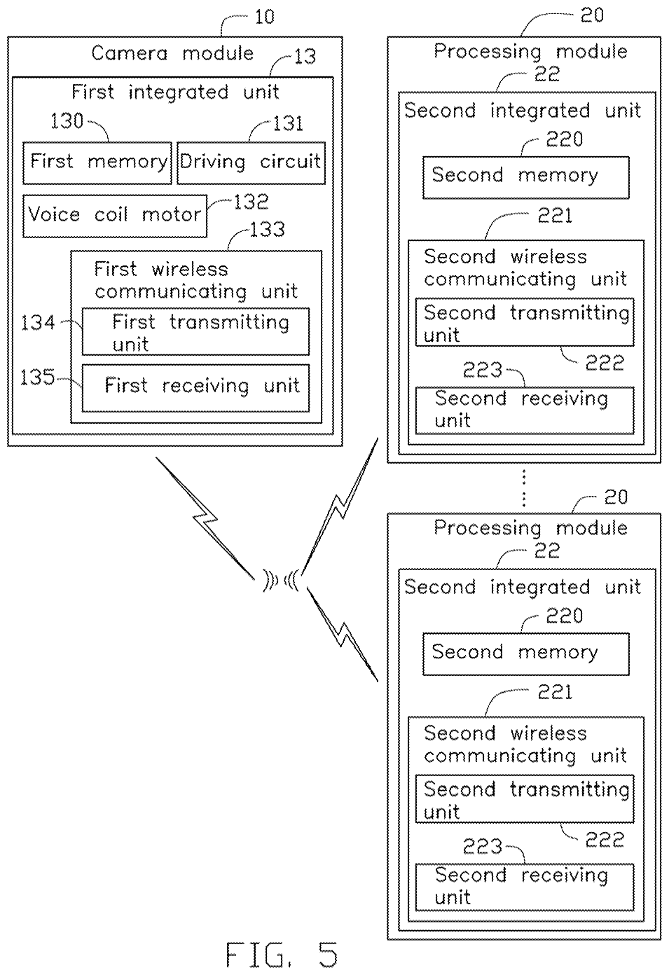

FIG. 5 illustrates a third embodiment of an image processing device. The image processing device 500 includes an image capturing module 10 and a plurality of processing systems 20. The image processing device 500 is used in a scenario when the image processing device 500 wirelessly communicates with a plurality of electronic devices 200. The first integrated unit 13 of the camera module 10 is connected to the second integrated unit 22 of each processing module 20 through a wireless communication connection for transmitting or/and receiving the signals.

The image processor 21 and the image sensor 12 are wirelessly connected through the non-contact communication connection to realize wireless data transmission. Thus, the connection between the image processor 21 and the image sensor 12 is stable and simple.

The embodiments shown and described above are only examples. Many details are often found in the relevant art. Therefore, many such details are neither shown nor described. Even though numerous characteristics and advantages of the present disclosure have been set forth in the foregoing description, together with details of the structure and function of the present disclosure, the disclosure is illustrative only, and changes may be made in the details, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. An image processing device comprising:
at least one a camera module, comprising:
a lens configured for obtaining an optical signal;
an image sensor configured for converting the optical signal into an electrical signal; and
a first integrated unit; and
at least one a processing module, comprising:
a processor configured for generating an image signal according to the electrical signal; and
a second integrated unit, wherein the first integrated unit and the second integrated unit establish a non-contact wireless communication connection therebetween, thereby realizing communications between the camera module and the processing module.

2. The image processing device of claim 1, wherein the camera module further comprises a first power supply unit configured for supplying electric power to the camera module, the processing module further comprises a second power supply unit configured for supplying electric power to the processing module.

3. The image processing device of claim 1, wherein the first integrated unit at least comprises a first memory, a driving circuit, a voice coil motor, and a first wireless communicating unit, the first memory is configured for storing the image signal, the driving circuit is configured for driving the image sensor, the voice coil motor is electrically connected to the lens, the voice coil motor is configured for adjusting a position of the lens, the first wireless communicating unit is configured for communicating with the second wireless communicating unit.

4. The image processing device of claim 3, wherein the second integrated unit at least comprises a second memory and a second wireless communicating unit, the second memory is configured for storing the image signal, the second wireless communicating unit is configured for configured for communicating with the first wireless communicating unit.

5. The image processing device of claim 4, wherein the first wireless communicating unit comprises a first transmitting unit and a first receiving unit, the second wireless communicating unit comprises a second transmitting unit and a second receiving unit, the first transmitting unit and the second transmitting unit are configured for transmitting signals to the second receiving unit and the first receiving unit, and the first receiving unit and the second receiving unit are configured for receiving the signals from the second transmitting unit and the first transmitting unit.

6. The image processing device of claim 4, wherein the first wireless communicating unit and the second wireless communicating unit are wirelessly connected through a wireless radio frequency connection, the signal transmitted between the first integrated unit and the second integrated unit at least comprises one of a Mobile Industry Processor Interface signal and an Inter-Integrated Circuit Serial bus signal.

7. The image processing device of claim 1, wherein the image processing device comprises a plurality of camera modules and a processing module, the first integrated unit of each of the camera modules is connected to the second integrated unit of the processing module through a wireless communication connection.

8. The image processing device of claim 1, wherein the image processing device comprises an image capturing module and a plurality of processing modules, the first integrated unit of the camera module is connected to the second integrated unit of each of the processing modules through a wireless communication connection.

9. An electronic device comprising:
a housing; and
an image processing device assembled to the housing, the image processing device comprising:
at least one a camera module, comprising:
a lens configured for obtaining an optical signal;
an image sensor configured for converting the optical signal into an electrical signal; and
a first integrated unit; and
at least one a processing module, comprising:
a processor configured for generating an image signal according to the electrical signal; and
a second integrated unit, wherein the first integrated unit and the second integrated unit establish a non-contact wireless communication connection therebetween, thereby realizing communications between the camera module and the processing module.

10. The electronic device of claim 9, wherein the camera module further comprises a first power supply unit configured for supplying electric power to the camera module, the processing module further comprises a second power supply unit configured for supplying electric power to the processing module.

11. The electronic device of claim 9, wherein the first integrated unit at least comprises a first memory, a driving circuit, a voice coil motor, and a first wireless communicating unit, the first memory is configured for storing the image signal, the driving circuit is configured for driving the image sensor, the voice coil motor is electrically connected to the lens, the voice coil motor is configured for adjusting a position of the lens, the first wireless communicating unit is configured for communicating with the second wireless communicating unit.

12. The electronic device of claim 11, wherein the second integrated unit at least comprises a second memory and a second wireless communicating unit, the second memory is configured for storing the image signal, the second wireless communicating unit is configured for configured for communicating with the first wireless communicating unit.

13. The electronic device of claim 12, wherein the first wireless communicating unit comprises a first transmitting unit and a first receiving unit, the second wireless communicating unit comprises a second transmitting unit and a second receiving unit, the first transmitting unit and the second transmitting unit are configured for transmitting signals to the second receiving unit and the first receiving unit, and the first receiving unit and the second receiving unit are configured for receiving the signals from the second transmitting unit and the first transmitting unit.

14. The electronic device of claim 12, wherein the first wireless communicating unit and the second wireless communicating unit are wirelessly connected through a wireless radio frequency connection, the signal transmitted between the first integrated unit and the second integrated unit at least comprises one of a Mobile Industry Processor Interface signal and an Inter-Integrated Circuit Serial bus signal.

15. The electronic device of claim 9, wherein the image processing device comprises a plurality of camera modules and a processing module, the first integrated unit of each of the camera modules is connected to the second integrated unit of the processing module through a wireless communication connection.

16. The electronic device of claim 9, wherein the image processing device comprises an image capturing module and a plurality of processing modules, the first integrated unit of the camera module is connected to the second integrated unit of each of the processing modules through a wireless communication connection.
